(19) United States
(12) Patent Application Publication
(10) Pub. No.: US 2026/0109127 A1
(43) Pub. Date: Apr. 23, 2026

(54) FLAP SPREADING DEVICE IN SQUARE BOTTOM FORMING DEVICE OF BAG MAKING MACHINE, SQUARE BOTTOM FORMING DEVICE IN BAG MAKING MACHINE, AND BAG MAKING MACHINE

(71) Applicant: NEWLONG INDUSTRIAL CO., LTD., Tokyo (JP)

(72) Inventors: Kento CHO, Tokyo (JP); Koki YAKUWA, Tokyo (JP); Takuya KUDO, Tokyo (JP)

(21) Appl. No.: 19/153,963

(22) PCT Filed: Nov. 6, 2024
(86) PCT No.: PCT/JP2024/039504

§ 371 Date: Aug. 6, 2025

(30) Foreign Application Priority Data
Dec. 22, 2023 (JP) 2023-216788

(51) Int. Cl. B31B 70/26; B31B 70/00; B31B 70/10; B31B 70/62; B31B 70/86

(52) U.S. Cl. CPC B31B 70/26; B31B 70/003; B31B 70/10; B31B 70/62; B31B 70/864

(57) ABSTRACT

A flap spreading device that folds back a front flap of a bottom portion of a flat tubular body, conveyed by a bottom folding drum, upside down with respect to a back flap and planarly spreads the front flap and the back flap along an outer peripheral surface of the bottom folding drum in a square bottom forming device of a bag making machine, and includes: a pair of guide plates that guides both side portions of the flat tubular body along a conveyance direction of the bottom folding drum to planarly spread the front flap and the back flap; a pair of robots having the pair of guide plates as end effectors; and a position and posture adjustment device that adjusts positions and postures of the pair of guide plates in a three-dimensional space to target positions and target postures through operations of the pair of robots.

### CROSS REFERENCE TO RELATED APPLICATIONS

This is a U.S. national stage of application No. PCT/JP2024/039504, filed on Nov. 6, 2024. Priority under 35 U. S. C. ∅119 (a) and 35 U. S. C. §365 (b) is claimed from Japanese Patent Applications No. 2023-216788 filed on Dec. 22, 2023.

### TECHNICAL FIELD

The present invention relates to a flap spreading device that planarly spreads a bottom portion of a flat tubular body conveyed by a bottom folding drum in a process of forming the bottom portion of the flat tubular body into a square bottom in a square bottom forming device of a bag making machine.

The invention relates to a square bottom forming device that forms a bottom portion of a flat tubular body into a square bottom in a bag making machine, the square bottom forming device including a flap spreading device.

The invention relates to a bag making machine that manufactures a square bottom bag, the bag making machine provided with a square bottom forming device including a flap spreading device.

### BACKGROUND ART

Examples of a flap spreading device in a square bottom forming device of a bag making machine include those illustrated in PTL 1 and PTL 2. Hereinafter, PTL 1 and PTL 2 will be described.

A flap fold-back device as a flap spreading device in PTL includes a pair of left and right guide plates disposed above a bottom folding drum, and a pair of left and right linear members disposed between the guide plates. The guide plate and the linear member are fixed to a mounting rod via a mounting arm. Each of the guide plates and each of the linear members guides a paper tube rotationally conveyed by the bottom folding drum between each of the guide plates and the bottom folding drum, and presses a front folding flap sucked by a bottom opening device against each of the guide plates and each of the linear members to fold back the front folding flap inside out from a bottom fold-back line. That is, the front folding flap and a back folding flap are planarly spread along the outer periphery of the bottom folding drum, and the paper tube is stably conveyed through a slight gap between the guide plate and the bottom folding drum while being suppressed from floating.

A flap fold-back device as a flap spreading device in PTL 2 includes a pair guide plates guiding both side portions of a bag mouth opened by a bottom opening device. The guide plate is substantially horizontally fixed to a mounting rod laterally provided in an upper portion of a bottom folding drum via a mounting arm. Each of the left and right guide plates has a flat plate portion and vertical portions hanging downward from both side ends of the flat plate portion. An inclined portion whose height gradually increases toward the outer edge is formed on one end side (bottom opening device side) of the flat plate portion, and the other end side of the flat plate portion is fixed to the mounting arm so as to be in contact with an outer peripheral surface of the bottom folding drum. Further, between the guide plates, a linear member that presses a central portion of a paper tube against the outer peripheral surface of the bottom folding drum is fixed to the mounting rod via a mounting arm. The paper tube rotationally conveyed by the bottom folding drum is guided between the left and right guide plates and the bottom folding drum, a front folding flap sucked by a bottom opening device is pressed against the flat plate portions of the respective guide plates, and the front folding flap is folded back inside out from a folding line by the rotation of the bottom folding drum. That is, only the front folding flap is folded back inside out with a back folding flap left to planarly spread the front and back folding flaps along the outer periphery of the bottom folding drum. In this manner, the paper tube in which the front and back folding flaps are spread by the flap fold-back device is conveyed in conjunction with the rotation of the bottom folding drum. At this time, both sides of each of the folding flaps are sandwiched between a press roller and the bottom folding drum to fold the folding flaps into a flat shape, and the paper tube is stably conveyed through a slight gap between the bottom folding drum and a curved guide regulating plate provided side by side with the bottom folding drum while suppressing floating of the paper tube.

### CITATION LIST

### Patent Literature

{PTL 1} JP 11-309793 A
{PTL 2} JP 8-90687 A

### SUMMARY OF INVENTION

### Technical Problem

In a bag making machine of the flap fold-back device of PTL 1, it is necessary to adjust positions and postures of the pair of left and right guide plates and positions and postures of the pair of left and right linear members depending on the material and thickness of base paper to be used, the size of a square bottom bag to be manufactured, and in order to maintain the quality of the square bottom bag for each predetermined number of manufactured sheets.

However, in the flap fold-back device of PTL 1, the pair of left and right guide plates and the pair of left and right linear members are fixed to the mounting rod via the mounting arms. Therefore, in the flap fold-back device of PTL 1, it is necessary to temporarily stop manufacturing work of the bag making machine in order to ensure the safety of a worker when the positions and the postures of the pair of left and right guide plates and the positions and the postures of the pair of left and right linear members are adjusted, and there a problem in manufacturing work efficiency.

Similarly, in a bag making machine of the flap fold-back device of PTL 2, it is necessary to adjust positions and postures of the pair of left and right guide plates and a position and a posture of the linear member depending on the material and thickness of base paper to be used, the size of a square bottom bag to be manufactured, and in order to maintain the quality of the square bottom bag for each predetermined number of manufactured sheets.

However, in the flap fold-back device of PTL 1, the pair of left and right guide plates is fixed to the mounting arms, and the linear member is fixed to the mounting rod via the mounting arm. Therefore, in the flap fold-back device of PTL 1, it is necessary to temporarily stop manufacturing work of the bag making machine in order to ensure the safety of a worker when the positions and the postures of the pair of left and right guide plates and the position and the posture of the linear member are adjusted, and there is a problem in manufacturing work efficiency.

An object of this invention is to provide a flap spreading device in a square bottom forming device of a bag making machine, the square bottom forming device in the bag making machine, and the bag making machine, which can ensure safety of a worker and adjusting at least a pair of guide plates of the flap spreading device even during manufacturing work of the bag making machine.

### Solution to Problem

In order to solve the above problems, a flap spreading device in a square bottom forming device of a bag making machine according to a first aspect of the invention is a flap spreading device that folds back a front flap of a bottom portion of a flat tubular body, conveyed by a bottom folding drum, upside down with respect to a back flap and planarly spreads the front flap and the back flap along an outer peripheral surface of the bottom folding drum in a square bottom forming device of a bag making machine, and includes: a pair of guide plates that guides both side portions of the flat tubular body along a conveyance direction of the bottom folding drum to planarly spread the front flap and the back flap; a pair of robots having the pair of guide plates as end effectors; and a position and posture adjustment device that adjusts positions and postures of the pair of guide plates in a three-dimensional space to target positions and target postures through operations of the pair of robots.

In the flap spreading device in the square bottom forming device of the bag making machine according to the invention, the position and posture adjustment device preferably includes: an input unit including a movement operation unit that receives information on the target positions and information on the target postures of the pair of guide plates; and a control unit that controls the operations of the pair of robots based on the information on the target positions and the information on the target postures input to the input unit by operating the movement operation unit.

In the flap spreading device in the square bottom forming device of the bag making machine according to the invention, the position and posture adjustment device preferably performs control to operate the pair of robots via the control unit when the information on the target positions and the information on the target postures are input to the input unit in order to adjust the positions and the postures of the pair of guide plates, and control to stop the operations of the pair of robots via the control unit until information on the target positions and information on the target postures are newly input to the input unit in order to maintain the adjusted positions and postures of the pair of guide plates.

In the flap spreading device in the square bottom forming device of the bag making machine according to the invention, the input unit preferably includes an offset operation unit that receives offset position information for causing the pair of guide plates, located at the target positions in the target postures, to be located at offset positions offset from the target positions, and the control unit preferably causes the pair of guide plates to be located at the offset positions offset from the target positions through the operations of the pair of robots by operating the offset operation unit.

In the flap spreading device in the square bottom forming device of the bag making machine according to the invention, the position and posture adjustment device preferably includes a storage unit in which the information on the target positions and the information on the target postures are stored, the input unit includes an information retrieval operation unit that retrieves the information on the target positions and the information on the target postures stored in the storage unit, and the control unit preferably controls the operations of the pair of robots based on the information on the target positions and the information on the target postures retrieved from the storage unit by operating the information retrieval operation unit.

In the flap spreading device in the square bottom forming device of the bag making machine according to the invention, the input unit preferably includes an offset operation unit that receives offset position information for causing the pair of guide plates, located at the target positions in the target postures, to be located at offset positions offset from the target positions, and the control unit preferably causes the pair of guide plates to be located at the offset positions offset from the target positions through the operations of the pair of robots by operating the offset operation unit.

In the flap spreading device in the square bottom forming device of the bag making machine according to the invention, the pair of guide plates is preferably attached to the pair of robots via a joint and a buffer material.

The flap spreading device in the square bottom forming device of the bag making machine according to the invention preferably further includes: a pair of guide bars that is arranged between the pair of guide plates and guides a central portion of the flat tubular body along the conveyance direction of the bottom folding drum to planarly spread the front flap and the back flap; and a guide bar robot having the pair of guide bars as end effectors, and the position and posture adjustment device preferably adjusts positions and postures of the pair of guide bars in the three-dimensional space to target positions and target postures through an operation of the guide bar robot.

In the flap spreading device in the square bottom forming device of the bag making machine according to the invention, the position and posture adjustment device preferably includes: an input unit including a movement operation unit that receives information on the target positions and information on the target postures of the pair of guide bars; and a control unit that controls the operation of the guide bar robot based on the information on the target positions and the information on the target postures input to the input unit by operating the movement operation unit.

In the flap spreading device in the square bottom forming device of the bag making machine according to the invention, the position and posture adjustment device preferably performs control to operate the guide bar robot via the control unit when the information on the target positions and the information on the target postures are input to the input unit in order to adjust the positions and the postures of the pair of guide bars, and control to stop the operation of the guide bar robot via the control unit until information on the target positions and information on the target postures are newly input to the input unit in order to maintain the adjusted positions and postures of the pair of guide bars.

In the flap spreading device in the square bottom forming device of the bag making machine according to the invention, a guide bar mounting member is preferably mounted to the guide bar robot, and the pair of guide bars is preferably mounted to the guide bar mounting member to be movable in at least one of the conveyance direction of the bottom folding drum and a direction intersecting the conveyance direction of the bottom folding drum.

In the flap spreading device in the square bottom forming device of the bag making machine according to the invention, a guide bar mounting member is preferably mounted to the guide bar robot via a joint and a buffer material, and the pair of guide bars is preferably mounted to the guide bar mounting member to be movable in at least one of the conveyance direction of the bottom folding drum and a direction intersecting the conveyance direction of the bottom folding drum.

In order to solve the above problems, a square bottom forming device in a bag making machine according to a first aspect of the invention is a square bottom forming device that forms a bottom portion of a flat tubular body into a square bottom in the bag making machine, and includes: a supply device that continuously supplies the flat tubular body at intervals; a bottom fold line forming device that forms a bottom fold-back line and a bottom folding line to the bottom portion of the flat tubular body in a direction perpendicular to a flow direction of a manufacturing line; a bottom folding drum that conveys the flat tubular body in the flow direction of the manufacturing line; an opening device that opens a front flap and a back flap of the bottom portion of the flat tubular body; the flap spreading device according to the invention that folds back the front flap inside out with respect to the back flap along the bottom fold-back line and planarly spreads the front flap and the back flap along an outer peripheral surface of the bottom folding drum; a glue applicator that applies glue to the front flap and the back flap which are planarly spread; a raising device that raises the front flap and the back flap to which the glue is applied along the bottom folding line; a sticking device that folds the raised front flap and the raised back flap along the bottom folding line and sticks the front flap and the back flap to each other with the glue; and a pressing device that presses the front flap and the back flap stuck with the glue to form the square bottom.

In order to solve the above problems, a bag making machine according to a first aspect of the invention is a bag making machine that manufactures a square bottom bag, and includes: a paper feeding device that continuously feeds base paper wound in a roll shape in a flow direction of a manufacturing line; a flat tubular body forming device that forms a flat tubular body having a flat tubular shape from the base paper fed from the paper feeding device; and the square bottom forming device according to the invention that forms a square bottom from a bottom portion of the flat tubular body formed by the flat tubular body forming device.

The bag making machine according to the invention preferably further includes a handle device that forms a handle and attaches the handle to a predetermined position of a mouth portion of the square bottom bag.

### Advantageous Effects of Invention

The flap spreading device in the square bottom forming device of the bag making machine, the square bottom forming device in the bag making machine, and the bag making machine according to the invention can ensure the safety of the worker, and can adjust at least the pair of guide plates of the flap spreading device even during the manufacturing work of the bag making machine.

### BRIEF DESCRIPTION OF DRAWINGS

FIG. 1 is a plan view illustrating an embodiment of a bag making machine, a square bottom forming device, and a flap spreading device according to the invention.

FIG. 2 is a side view illustrating the embodiment of the bag making machine, the square bottom forming device, and the flap spreading device according to the invention.

FIG. 3 is a front view illustrating a square bottom bag with a rope handle.

FIG. 4 is a partial perspective view illustrating a state in which rope handles are attached to base paper.

FIG. 5 is a partial perspective view illustrating a continuous flat tubular body.

FIG. 6 is a perspective view illustrating a flat tubular body including two sets of rope handles at a mouth portion.

FIG. 7 is a perspective view illustrating a state in which a front flap and a back flap of a bottom portion of the flat tubular body are opened.

FIG. 8 is a perspective view illustrating a state in which the opened front flap is folded back inside out with respect to the back flap along a bottom fold-back line.

FIG. 9 is a perspective view illustrating a state in which the front flap and the back flap are planarly spread along an outer peripheral surface of a bottom folding drum.

FIG. 10 is a perspective view illustrating a state in which glue is applied to the front flap and the back flap which are planarly spread.

FIG. 11 is a perspective view illustrating a square bottom bag in which a square bottom is formed in the bottom portion of the flat tubular body.

FIG. 12 is a side view illustrating the flap spreading device.

FIG. 13 is a front view illustrating the flap spreading device.

FIG. 14 is a perspective view illustrating the flap spreading device.

FIG. 15 is a perspective view illustrating a retracted state of a pair of guide plates on the left and right sides and a pair of left and right guide bars of the flap spreading device.

FIG. 16 is an explanatory view illustrating a left guide plate 60L. (A) is a plan view. (B) is a rear view (viewed in a direction of arrow B in (A)). (C) is a side view (viewed in a direction of arrow C in (A)). (D) is a perspective view (viewed in a direction of arrow D in (A)). (E) is a front view (viewed in a direction of arrow E in (C)).

FIG. 17 is a front view illustrating a sixth arm, a joint, a buffer material, and the pair of guide plates on the left and right sides of a pair of left and right guide plate robots.

FIG. 18 is a side view (viewed in a direction of arrow XVIII in FIG. 17) illustrating the sixth arm, the joint, the buffer material, and the pair of guide plates on the left and right sides of the pair of left and right guide plate robots.

FIG. 19 is a bottom view (viewed in a direction of line XIX-XIX in FIG. 17) illustrating the sixth arm and the joint of the pair of left and right guide plate robots.

FIG. 20 is a bottom view (viewed in a direction of line XIX-XIX in FIG. 17) illustrating mounting portions of the sixth arm, the joint, and the pair of guide plates on the left and right sides of the pair of left and right guide plate robots.

FIG. 21 is a front view illustrating the sixth arm, the joint, the buffer material, a mounting member, and the pair of left and right guide bars of the pair of left and right guide bar robots.

FIG. 22 is a side view (viewed in a direction of arrow XXII in FIG. 21) illustrating the sixth arm, the joint, the buffer material, the mounting member, and the pair of left and right guide bars of the pair of left and right guide bar robots.

FIG. 23 is a block diagram illustrating a position and posture adjustment device.

FIG. 24 is a block diagram illustrating a first input unit.

FIG. 25 is a front view illustrating a square bottom bag with an external flat handle.

### DESCRIPTION OF CONFIGURATIONS OF EMBODIMENTS

Hereinafter, an example of an embodiment (Example) of a flap spreading device in a square bottom forming device of a bag making machine according to the invention (hereinafter, referred to as the “flap spreading device”), an example of an embodiment (Example) of a square bottom forming device in a bag making machine according to the invention (hereinafter, referred to as the “square bottom forming device”), and an example of an embodiment (Example) of a bag making machine according to the invention will be described with reference to the drawings. Note that the invention is not limited by the embodiments. In addition, constituent elements in the following embodiments include those that can be easily replaced by those skilled in the art or those that are substantially the same.

In this specification, a downstream side and an upstream side of flow of a manufacturing line of base paper, a flat tubular body, and a square bottom bag are defined as a front side and a rear side, respectively. A left side and a right side when viewing the front side that is the downstream side from the rear side that is the upstream side are defined as a left side and a right side, respectively. An upper side in the vertical direction is defined as an upper side, and a lower side in the vertical direction is defined as a lower side.

Note that the drawings are schematic views illustrating the flap spreading device, the square bottom forming device, and the bag making machine according to the invention, and thus main components of the flap spreading device, the square bottom forming device, and the bag making machine according to the invention are illustrated, and illustrations of components other than the main components are omitted. In addition, hatching is partially omitted. Further, in figures, reference sign “A” of an arrow indicates a flow direction of the manufacturing line of the base paper, the flat tubular body, and the square bottom bag, and the arrow is directed from the upstream side to the downstream side. In addition, in figures, reference signs “F”, “B”, “L”, “R”, “U”, and “D” indicate the “front side”, the “rear side”, the “left side”, the “right side”, the “upper side”, and the “lower side”, respectively.

### Description of Configurations of Embodiments

Hereinafter, configurations of the flap spreading device, the square bottom forming device, and the bag making machine according to an embodiment will be described.

### Description of Bag Making Machine 1

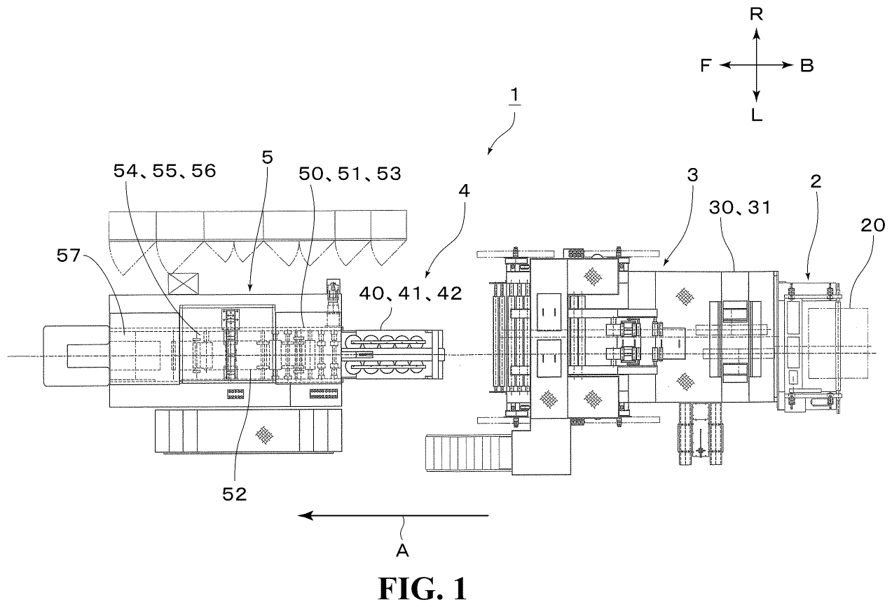

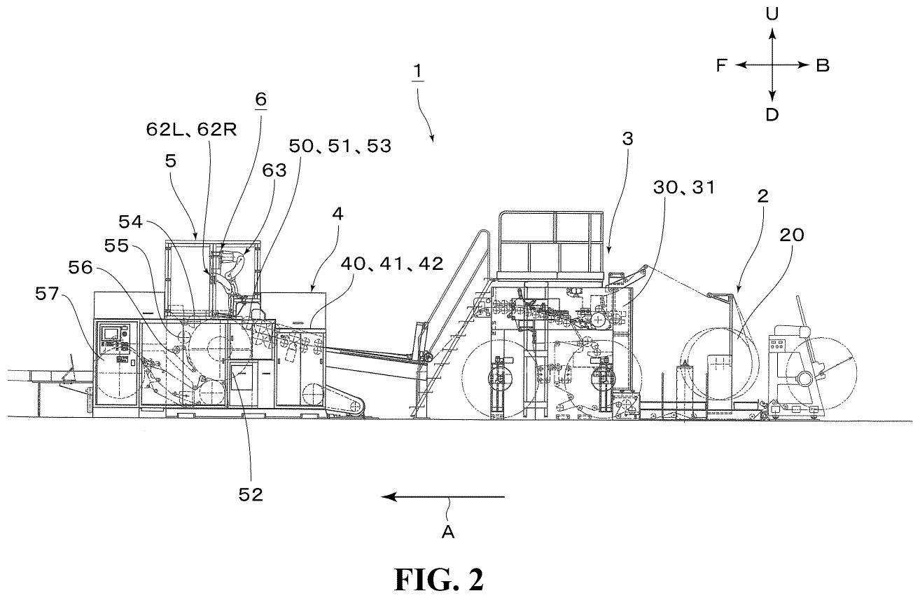

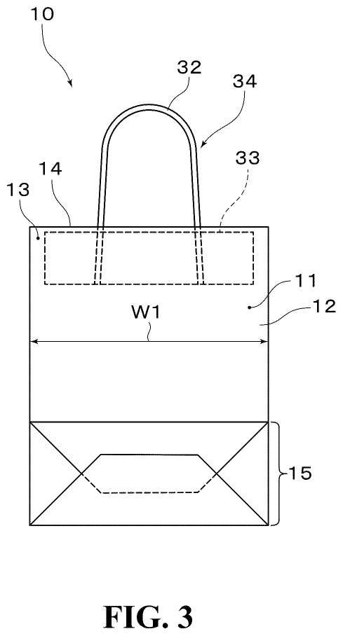

FIG. 1 is a plan view illustrating a bag making machine 1, and FIG. 2 is a side view illustrating the bag making machine 1. In this example, the bag making machine 1 manufactures a square bottom bag 10 with rope handles 34 (the square bottom bag 10 including the rope handles 34, hereinafter referred to as the “square bottom bag 10”) illustrated in FIGS. 3 and 11.

As illustrated in FIGS. 1 and 2, the bag making machine 1 includes a paper feeding device 2, a handle device 3, a flat tubular body forming device 4, and a square bottom forming device 5.

### Description of Paper Feeding Device 2

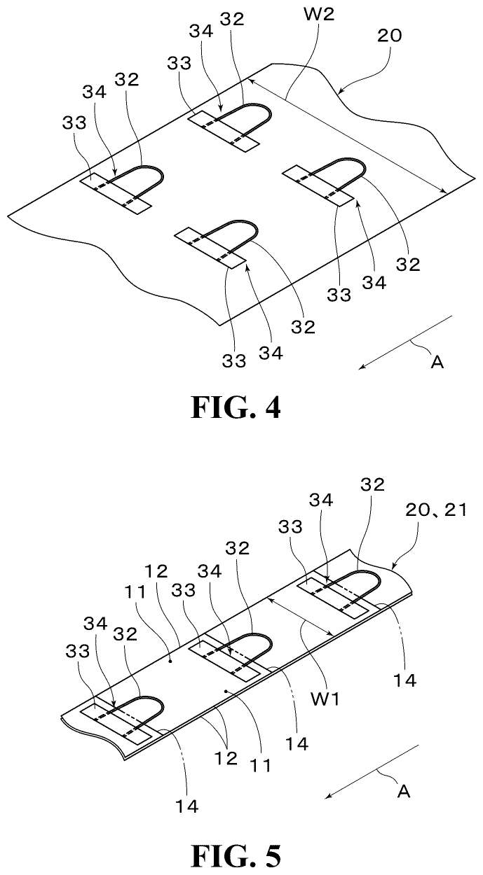

The paper feeding device 2 is arranged most upstream of the bag making machine 1. The paper feeding device 2 continuously feeds base paper 20 wound in a roll shape in the flow direction A of the manufacturing line. As illustrated in FIGS. 3 and 4, a width W2 of the base paper 20 wound in a roll shape is set based on a width W1 of the square bottom bag 10.

The width W2 of the base paper 20 is a dimension in a direction perpendicular to the flow direction A of the manufacturing line of the base paper 20. In addition, the material, thickness, and the like of the base paper 20 are set in any manner. Further, there is a case where printing or the like is performed on a front surface of the base paper 20.

### Description of Handle Device 3

As illustrated in FIGS. 1 and 2, the handle device 3 is arranged between the paper feeding device 2 and the flat tubular body forming device 4. That is, the handle device 3 is arranged on the downstream side of the paper feeding device 2, and includes a handle forming device 30 and a handle attaching device 31.

The handle forming device 30 integrates a U-shaped rope handle portion 32 and an attachment sheet 33 to form a rope handle 34 (see FIGS. 3 to 11). The attachment sheet 33 also functions as a reinforcing sheet.

The handle attaching device 31 applies glue (not illustrated) to a predetermined position of the base paper 20. In addition, as illustrated in FIG. 4, the handle attaching device 31 attaches the rope handles 34 to the applied glue. The rope handles 34 are arranged one by one on the left and right sides of the base paper 20.

### Description of Flat Tubular Body Forming Device 4

As illustrated in FIGS. 1 and 2, the flat tubular body forming device 4 is arranged on the downstream side of the handle attaching device 31, and includes a gusset line forming device 40, a gusset attaching device 41, and a cutting device 42.

In the gusset line forming device 40, gusset lines 12 are provided in the flow direction A of the manufacturing line at predetermined locations of the base paper 20 in which the rope handles 34 are arranged one by one on the left and right sides, that is, at locations corresponding to gusset portions 11 on both the left and right sides of the square bottom bag 10.

The gusset attaching device 41 applies glue (not illustrated) to at least one of left and right side edges along the flow direction A of the manufacturing line of the base paper 20 in which the rope handles 34 are arranged one by one on the left and right sides. In addition, as illustrated in FIG. 5, the gusset attaching device 41 folds the base paper 20 along the gusset lines 12 and attaches the base paper with an adhesive to form a continuous flat tubular body 21.

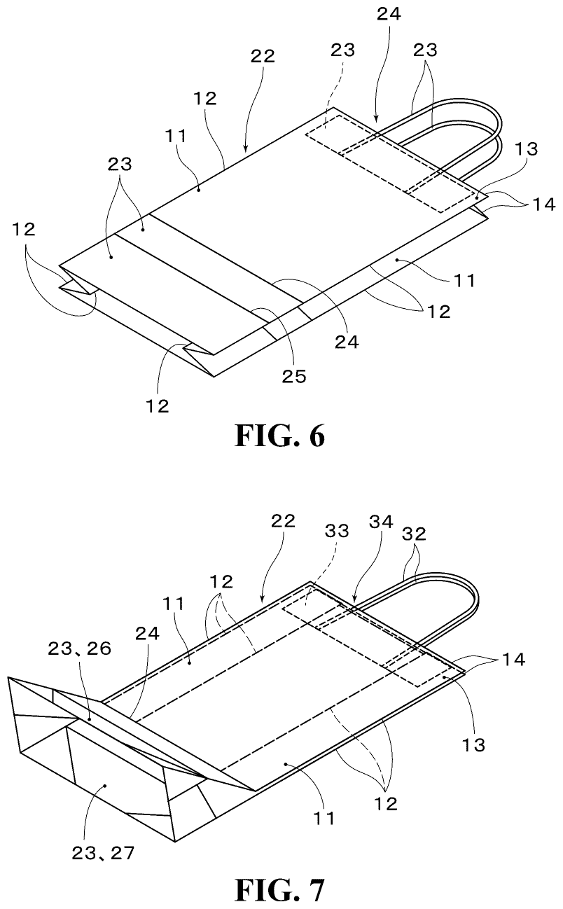

As illustrated in FIG. 5, the cutting device 42 cuts a predetermined location of the continuous flat tubular body 21, that is, a location corresponding to an opening edge 14 of a mouth portion 13 of the square bottom bag 10 illustrated in FIGS. 3 and 11 (see a two-dot chain line in FIG. 5) in the direction perpendicular to the flow direction A of the manufacturing line. Thus, as illustrated in FIG. 6, a flat tubular body 22 including two sets of the rope handles 34 in the mouth portion 13 is formed.

### Description of Square Bottom Forming Device 5

As illustrated in FIGS. 1 and 2, the square bottom forming device 5 is arranged on the downstream side of the flat tubular body forming device 4, and includes a supply device 50, a bottom fold line forming device 51, a bottom folding drum 52, an opening device 53, a flap spreading device 6, a glue applicator 54, a raising device 55, a sticking device 56, and a pressing device 57.

The supply device 50 is arranged on the downstream side of the flat tubular body forming device 4, and continuously supplies the flat tubular body 22 (see FIG. 6) formed by the flat tubular body forming device 4 at intervals.

The bottom fold line forming device 51 is arranged on the downstream side of the supply device 50. As illustrated in FIG. 6, the bottom fold line forming device 51 forms a bottom fold-back line 24 and a bottom folding line 25 to a bottom portion 23 (portion corresponding to a square bottom 15 of the square bottom bag 10 illustrated in FIGS. 3 and 11) of the flat tubular body 22 in the direction perpendicular to the flow direction A of the manufacturing line. £ The bottom fold-back line 24 and the bottom folding line 25 are parallel to each other.

The bottom folding drum 52 rotationally convey the flat tubular body 22 on which the bottom fold-back line 24 and the bottom folding line 25 formed by the bottom fold line forming device 51 by rotation in the flow direction A of the manufacturing line. The bottom folding drum 52 is provided with a catching claw (not illustrated).

The opening device 53 is arranged on the downstream side of the bottom fold line forming device 51 and is arranged close to an outer peripheral surface of the bottom folding drum 52. The opening device 53 is provided with a suction pad (not illustrated). As illustrated in FIG. 7, the suction pad sucks a front flap 26 of the bottom portion 23 of the flat tubular body 22 to be open with respect to a back flap 27 of the bottom portion 23 of the flat tubular body 22. At this time, the back flap 27 is caught by the catching claw of the bottom folding drum 52, and is rotationally conveyed along the outer peripheral surface of the bottom folding drum 52. Thus, as illustrated in FIG. 7, the front flap 26 and the back flap 27 of the bottom portion 23 of the flat tubular body 22 are opened.

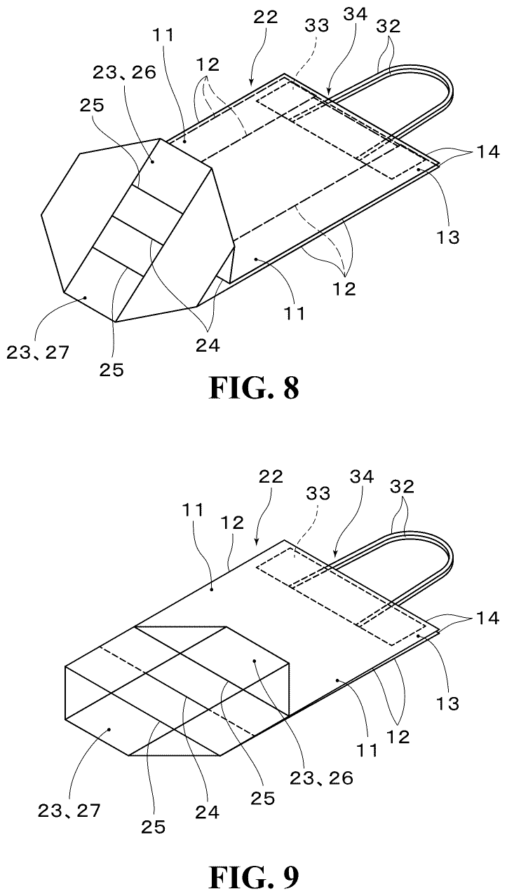

As illustrated in FIGS. 8 and 9, the flap spreading device 6 folds back the front flap 26 opened by the opening device 53 inside out with respect to the back flap 27 along the bottom fold-back line 24 to planarly spread the front flap 26 and the back flap 27 along the outer peripheral surface of the bottom folding drum 52. Note that the flap spreading device 6 will be described in detail later.

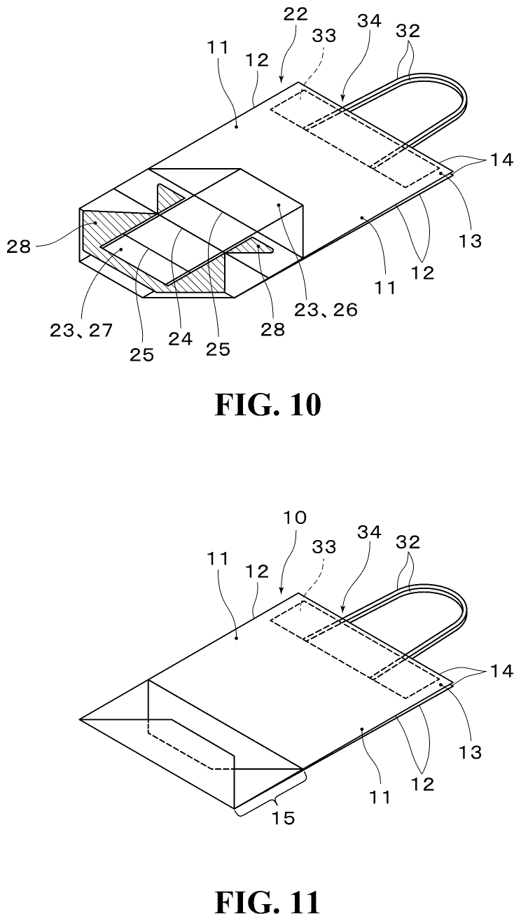

The glue applicator 54 is arranged on the downstream side of the flap spreading device 6 and on the outer peripheral surface of the bottom folding drum 52. As illustrated in FIG. 10, the glue applicator 54 applies glue 28 (see hatched portions in FIG. 10) to the front flap 26 and the back flap 27 which are planarly spread.

The raising device 55 is arranged on the downstream side of the glue applicator 54 and on the outer peripheral surface of the bottom folding drum 52. The raising device 55 raises the front flap 26 and the back flap 27 coated with the glue 28 along the bottom folding line 25.

The sticking device 56 is arranged on the downstream side of the raising device 55 and on the outer peripheral surface of the bottom folding drum 52. As illustrated in FIG. 11, the sticking device 56 folds the raised front flap 26 and back flap 27 along the bottom folding line 25 to be stuck with the glue 28.

As illustrated in FIGS. 1 and 2, the pressing device 57 is arranged on the downstream side of the sticking device 56. As illustrated in FIGS. 3 and 11, the pressing device 57 presses the front flap 26 and the back flap 27 stuck with the glue 28 to form the square bottom 15 on the bottom portion 23 of the flat tubular body 22. Thus, the square bottom bag 10 is manufactured.

### Description of Flap Spreading Device 6

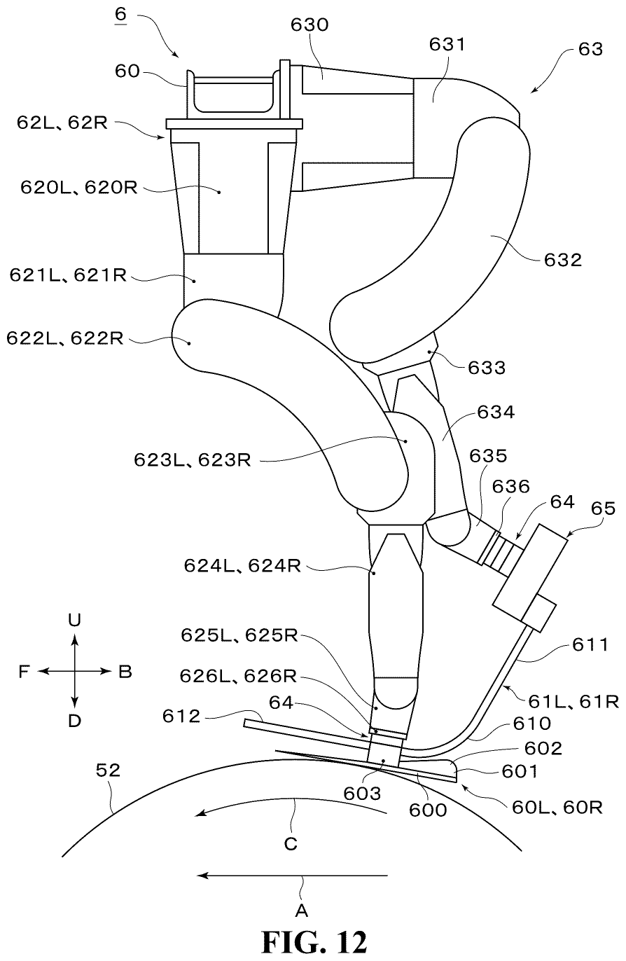

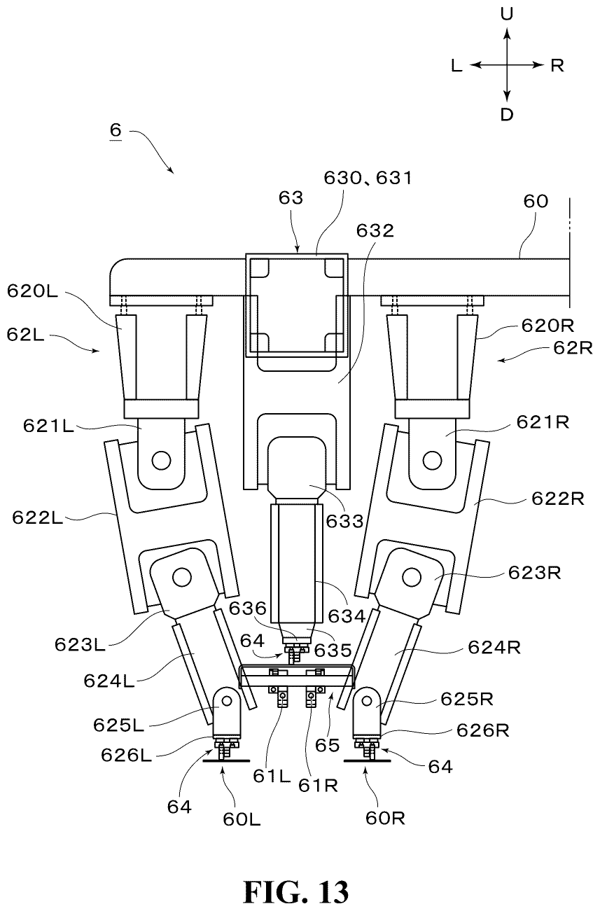

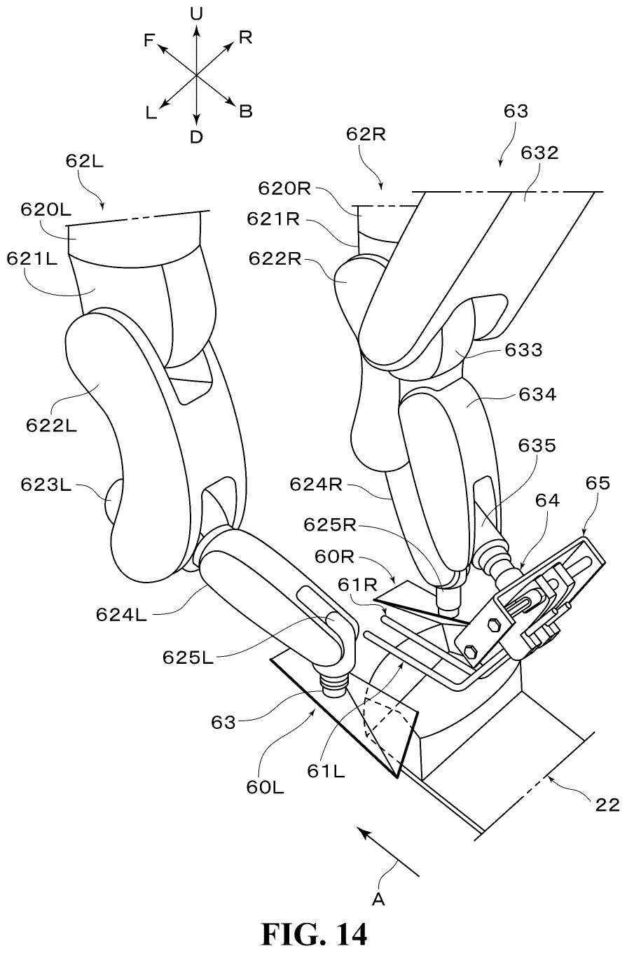

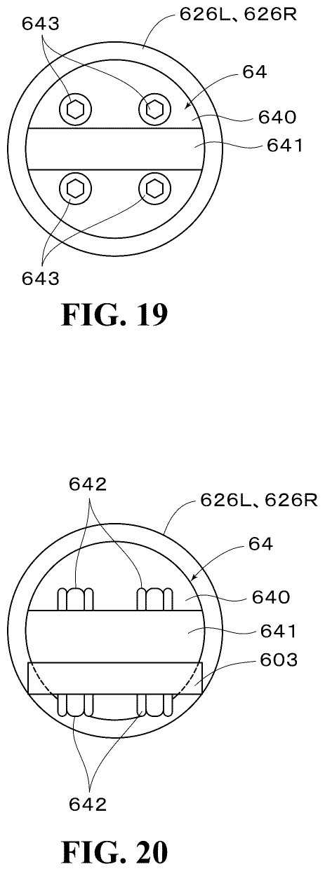

As illustrated in FIGS. 12 to 24, the flap spreading device 6 includes a pair of guide plates (or referred to as binders) 60L and 60R on the left and right sides, a pair of left and right guide bars (or referred to as a “rolling bar”) 61L and 61R, a pair of left and right guide plate robots 62L and 62R, a guide bar robot 63, and a position and posture adjustment device 7.

### Description of Pair of Guide Plates 60L and 60R on Left and Right Sides

The pair of guide plates 60L and 60R on the left and right sides is mounted, as end effectors of the pair of left and right guide plate robots 62L and 62R, to the pair of left and right guide plate robots 62L and 62R via joints 64 described later.

Note that the guide plate 60L on the left side out of the pair of guide plates 60L and 60R on the left and right sides may be hereinafter referred to as a “left guide plate 60L”. In addition, the guide plate 60R on the right side out of the pair of guide plates 60L and 60R on the left and right sides may be hereinafter referred to as a “right guide plate 60R”.

The pair of guide plates 60L and 60R on the left and right sides guides left and right side portions of the flat tubular body 22 along a rotational conveyance direction C of the bottom folding drum 52 to planarly spread the front flap 26 and the back flap 27 in a process of folding back the front flap 26 inside out with respect to the back flap 27 along the bottom fold-back line 24.

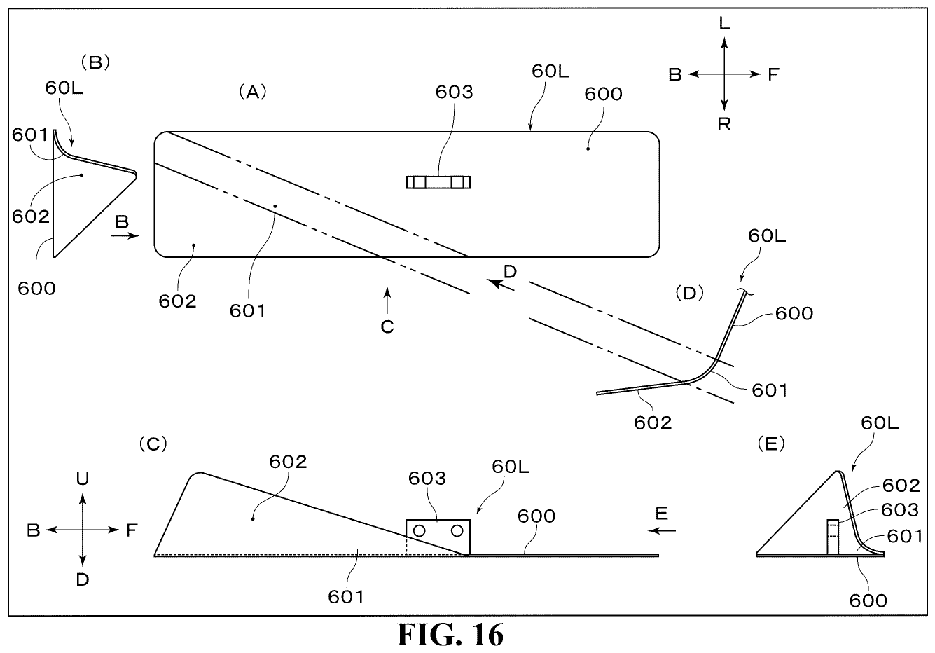

FIG. 16 is an explanatory view illustrating the left guide plate 60L. Hereinafter, the left guide plate 60L will be described. Since the right guide plate 60R is bilaterally symmetrical with the left guide plate 60L, the description of the right guide plate 60R is omitted. The guide plate 60L includes a horizontal plate portion 600, a curved portion 601, a rising plate portion 602, and a mounting portion 603.

The horizontal plate portion 600 has a rectangular plate shape, adjacently opposes the outer peripheral surface of the bottom folding drum 52, and presses the left and right side portions of the flat tubular body 22 against the outer peripheral surface of the bottom folding drum 52.

The rising plate portion 602 is formed by raising a part of the horizontal plate portion 600 with the curved portion 601 interposed therebetween, and guides both the left and right side portions of the flat tubular body 22 to the horizontal plate portion 600 together with the curved portion 601.

The rising plate portion 602 is integrally provided at a central portion of an upper surface of the horizontal plate portion 600, and is mounted to the guide plate robots 62L and 62R via the joints 64.

### Description of Pair of Left and Right Guide Bars 61L and 61R

The pair of left and right guide bars 61L and 61R is mounted to the guide bar robot 63, as an end effector of the guide bar robot 63, via the joint 64 and a guide bar mounting member 65 described later. Note that the pair of left and right guide bars 61L and 61R may be hereinafter referred to as “central guide bar 61L and 61R”.

The pair of left and right guide bars 61L and 61R is arranged between the pair of guide plates 60L and 60R on the left and right sides. The pair of left and right guide bars 61L and 61R guides a central portion of the flat tubular body 22 along the rotational conveyance direction C of the bottom folding drum 52 to planarly spread the front flap 26 and the back flap 27 in the process of folding back the front flap 26 upside down with respect to the back flap 27 along the bottom fold-back line 24.

As illustrated in FIG. 12, the pair of left and right guide bars 61L and 61R is formed by curving a central portion 610 of a round bar member. One end portions 611 of the pair of left and right guide bars 61L and 61R are mounted to the guide bar robot 63 via the guide bar mounting member 65. The other end portions 612 of the pair of left and right guide bars 61L and 61R are arranged between the pair of guide plates 60L and 60R on the left and right sides, adjacently oppose the outer peripheral surface of the bottom folding drum 52, and are pressed against the outer peripheral surface of the bottom folding drum 52 while guiding the central portion of the flat tubular body 22.

### Description of Pair of Left and Right Guide Plate Robots 62L and 62R

As illustrated in FIGS. 12 to 15, the pair of left and right guide plate robots 62L and 62R is provided on both left and right side portions of a ceiling support 60. The ceiling support 60 has an integral structure with a support (not illustrated) of the square bottom forming device 5, and is arranged on a ceiling portion of the square bottom forming device 5 in the left-right direction perpendicular to the flow direction A of the manufacturing line.

Note that the left guide plate robot 62L out of the pair of left and right guide plate robots 62L and 62R may be hereinafter referred to as a “first robot 62L”. In addition, the right guide plate robot 62R out of the pair of left and right guide plate robots 62L and 62R may be hereinafter referred to as a “third robot 62R”.

The pair of left and right guide plate robots 62L and 62R includes fixed arms 620L and 620R, first arms 621L and 621R, second arms 622L and 622R, third arms 623L and 623R, fourth arms 624L and 624R, fifth arms 625L and 625R, and sixth arms 626L and 626R.

The fixed arms 620L and 620R are fixed to the left and right side portions of the ceiling support 60. The first arms 621L and 621R are mounted to the fixed arms 620L and 620R so as to be rotatable about a first axis (not illustrated). The second arms 622L and 622R are mounted to the first arms 621L and 621R so as to be rotatable about a second axis (not illustrated). The third arms 623L and 623R are mounted to the second arms 622L and 622R so as to be rotatable about a third axis (not illustrated). The fourth arms 624L and 624R are mounted to the third arms 623L and 6213R so as to be rotatable about a fourth axis (not illustrated). The fifth arms 625L and 625R are mounted to the fourth arms 624L and 624R so as to be rotatable about a fifth axis (not illustrated). The sixth arms 626L and 626R are mounted to the fifth arms 625L and 625R So as to be rotatable about a sixth axis (not illustrated).

The first arms 621L and 621R to the sixth arms 626L and 626R are rotationally driven by servo motors. The pair of guide plates 60L and 60R on the left and right sides is mounted to the sixth arms 626L and 626R via the joints 64.

### Description of Guide Bar Robot 63

As illustrated in FIGS. 12 to 15, the guide bar robot 63 is provided between the pair of left and right guide plate robots 62L and 62R at a central portion of the ceiling support 60. Note that the guide bar robot 63 may be hereinafter referred to as a “second robot 63”.

The guide bar robot 63 includes a fixed arm 630, a first arm 631, a second arm 632, a third arm 633, a fourth arm 634, a fifth arm 635, and a sixth arm 636.

The fixed arm 630 is fixed to the central portion of the ceiling support 60. The first arm 631 is mounted to the fixed arm 630 so as to be rotatable about a first axis (not illustrated). The second arm 632 is mounted to the first arm 631 so as to be rotatable about a second axis (not illustrated). The third arm 633R is mounted to the second arm 632 so as to be rotatable about a third axis (not illustrated). The fourth arm 634 is mounted to the third arm 633 so as to be rotatable about a fourth axis (not illustrated). The fifth arm 635 is mounted to the fourth arm 634 so as to be rotatable about a fifth axis (not illustrated). The sixth arm 636 is mounted to the fifth arm 635 so as to be rotatable about a sixth axis (not illustrated).

The first arm 631 to the sixth arm 636 are rotationally driven by servo motors. The pair of left and right guide bars 61L and 61R is mounted to the sixth arm 636 via the joint 64 and the guide bar mounting member 65.

### Description of Joint 64

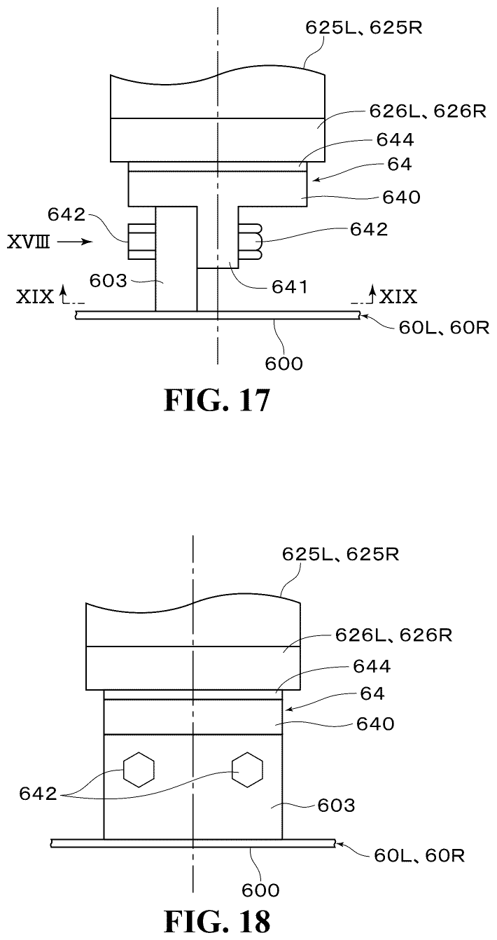

As illustrated in FIGS. 17 to 22, the joint 64 includes a disk-shaped main body portion 640 and a plate-shaped mounting portion 641 integrally provided at a central portion of one surface (lower surface) of the main body portion 640.

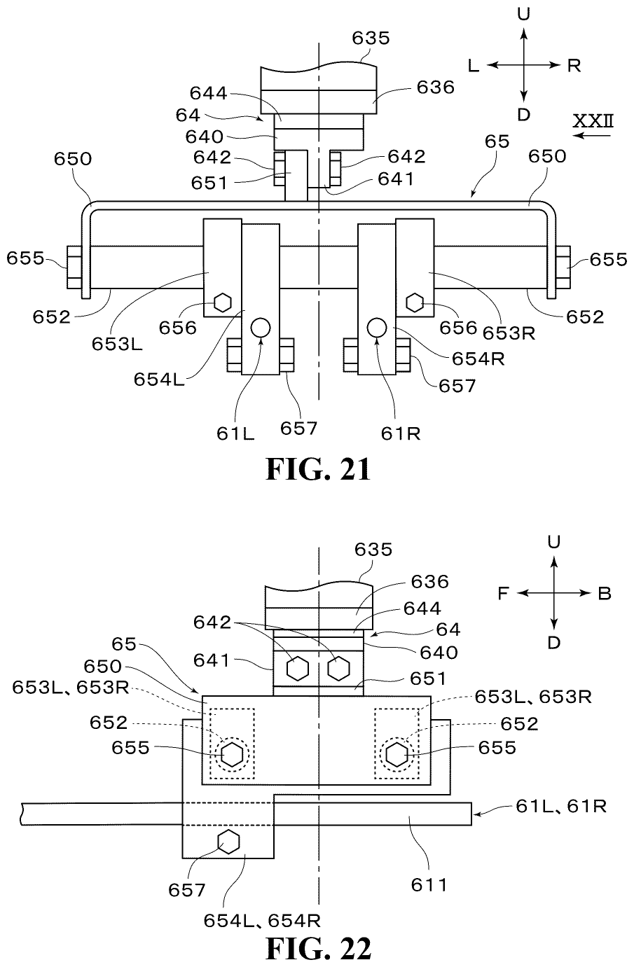

As illustrated in FIGS. 17 to 20, the other surface (upper surface) of the main body portion 640 is mounted, by a bolt 643, to one surface (lower surface) of each of the sixth arms 626L and 626R of the pair of left and right guide plate robots 62L and 62R with a buffer material 644 interposed therebetween. In addition, as illustrated in FIGS. 21 and 22, the other surface (upper surface) of the main body portion 640 is mounted, by a bolt 643, to one surface (lower surface) of the sixth arm 636 of the guide bar robot 63 with the buffer material 644 interposed therebetween. The buffer material 644 may be of one type or a plurality of types.

As illustrated in FIGS. 17, 18, and 20, the mounting portions 603 of the pair of guide plates 60L and 60R on the left and right sides are mounted to the mounting portions 641 by bolts and nuts 642. In addition, a first mounting portion 651 of the guide bar mounting member 65 is mounted to the mounting portion 641 by bolts and nuts 642 as illustrated in FIGS. 21 and 22.

### Description of Guide Bar Mounting Member 65

As illustrated in FIGS. 21 and 22, the guide bar mounting member 65 includes a main body portion 650, the first mounting portion 651, two mounting shafts 652, a pair of left and right sliding portions 653L and 653R, and a pair of left and right second mounting portions 654L and 654R.

The main body portion 650 has a shape in which left and right end portions of a rectangular plate member, which is long in the left-right direction, are bent downward. The first mounting portion 651 is integrally provided at a central portion of an upper surface of the main body portion 650. The first mounting portion 651 is mounted to the mounting portion 641 of the joint 64 by the bolts and nuts 642. Both end surfaces of the two mounting shafts 652 are mounted to the front and rear of the left and right end portions of the main body portion 650 by bolts 655.

The pair of left and right sliding portions 653L and 653R are mounted to the two mounting shafts 652 so as to be slidable in the left-right direction by bolts and nuts 656. The pair of left and right second mounting portions 654L and 654R is integrally provided on inner surfaces of the pair of left and right sliding portions 653L and 653R, that is, surfaces of the pair of left and right sliding portions 653L and 653R opposing each other.

The pair of left and right second mounting portions 654L and 654R is slidable in the left-right direction with respect to the two mounting shafts 652 together with the pair of left and right sliding portions 653L and 653R. The one end portions 611 of the pair of left and right guide bars 61L and 61R are mounted to the pair of left and right second mounting portions 654L and 654R by bolts and nuts 657 so as to be slidable in the front-rear direction.

Note that the pair of left and right guide bars 61L and 61R is mounted to the guide bar mounting member 65 so as to be movable in the left-right direction and the front-rear direction, but may be mounted so as to be movable in the left-right direction or the front-rear direction.

### Description of Position and Posture Adjustment Device 7

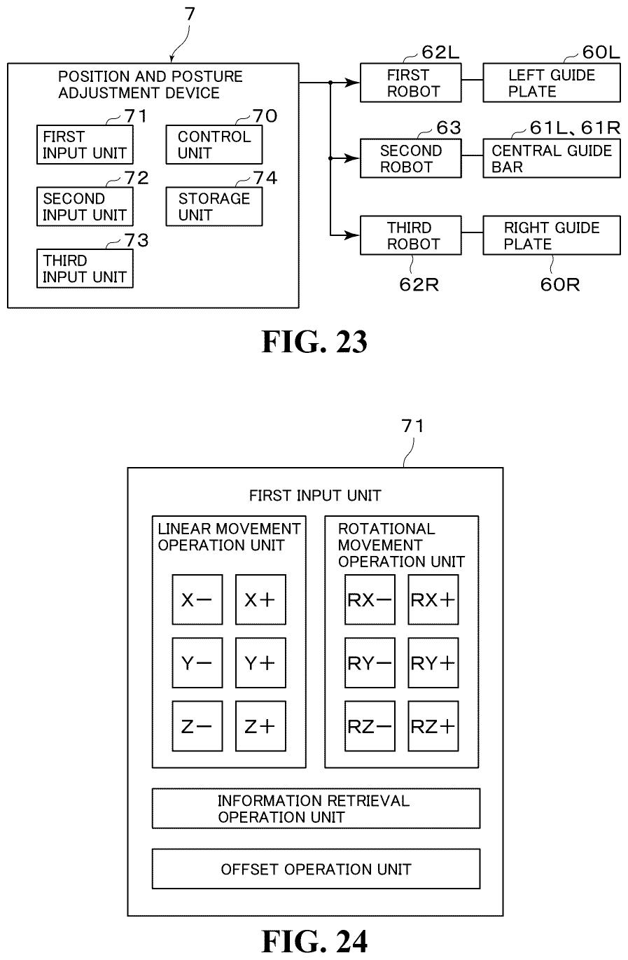

The position and posture adjustment device 7 is, for example, a personal computer, and includes a first input unit 71, a second input unit 72, a third input unit 73, a storage unit 74, and a control unit 70 as illustrated in FIG. 23.

The first input unit 71 adjusts a position and a posture of the left guide plate 60L via the first robot 62L by operating an operation unit. The second input unit 72 adjusts positions and postures of the central guide bars 61L and 61R via the second robot 63 by operating an operation unit. The third input unit 73 adjusts a position and a posture of the right guide plate 60R via the third robot 62R by operating an operation unit.

Hereinafter, the first input unit 71 will be described with reference to FIG. 24. Note that the second input unit 72 and the third input unit 73 have the same configuration as that of the first input unit 71, the description thereof will be omitted.

As illustrated in FIG. 24, the first input unit 71 includes six linear movement operation units, six rotational movement operation units, an information retrieval operation unit, and an offset operation unit.

When a worker who is an operator operates the six linear movement operation units and the six rotational movement operation units, information on a target position and information on a target posture in a three-dimensional space of the left guide plate 60L are input to the first input unit 71. In addition, when the worker operates the information retrieval operation unit, the information on the target position and the information on the target posture stored in the storage unit 74 are retrieved and input to the first input unit 71. Further, when the worker operates the offset operation unit, offset position information is input to the first input unit 71. The offset position information is information for positioning the left guide plate 60L, located at the target position in the target posture, at an offset position offset from the target position.

In this example, the position and the posture in the three-dimensional space are expressed by a right-handed orthogonal coordinate system having a predetermined point as an origin. An X axis is the front-rear direction, and the front side F is + and the rear side B is −. A Y axis is the left-right direction, the right side R is +, and the left side L is −. The Z axis is the up-down direction, and the upper side U is + and the lower side D is −. A clockwise direction about the X axis is +, and a counterclockwise direction about the X axis is −.A clockwise direction about the Y axis is +, and a counterclockwise direction about the Y axis is −. A clockwise direction about the Z axis is +, and a counterclockwise direction about the Z axis is −. Note that the position and the posture in the three-dimensional space may be expressed by a left-handed orthogonal coordinate system.

The storage unit 74 includes, for example, a RAM, a solid state drive (SSD), and a hard disk drive (HDD). The storage unit 74 stores information on the target position and information on the target posture of the left guide plate 60L, information on target positions and target postures of the central guide bars 61L and 61R, and information on a target position and a target posture of the right guide plate 60R. The information on the target position and the information on the target posture stored in the storage unit 74 are retrieved by the operations of the information retrieval operation units of the first input unit 71, the second input unit 72, and the third input unit 73.

The information on the target position and the information on the target posture stored in the storage unit 74 are information obtained by the worker operating the operation units of the first input unit 71, the second input unit 72, and the third input unit 73, information obtained by a skilled worker operating the operation units of the first input unit 71, the second input unit 72, and the third input unit 73, and the like.

The control unit 70 includes other elements including a central processing unit (CPU) and a storage part (a read only memory (ROM), a random access memory (RAM), a nonvolatile memory, or the like). By operating the six linear movement operation units and the six rotational movement operation units, the control unit 70 controls the operation of the first robot 62L, the operation of the second robot 63, and the operation of the third robot 62R based on the information on the target position and the information on the target posture of the left guide plate 60L, the information on the target positions and the information on the target postures of the central guide bars 61L and 61R, the information on the target position and the information on the target posture of the right guide plate 60R, which are input to the first input unit 71, the second input unit 72, and the third input unit 73 (which may be referred to as “input unit 71, 72, and 73” hereinafter).

The control unit 70 controls the operation of the first robot 62L, the operation of the second robot 63, and the operation of the third robot 62R based on the information on the target position and the information on the target posture of the left guide plate 60L, the information on the target positions and the information on the target postures of the central guide bars 61L and 61R, and the information on the target position and the information on the target posture of the right guide plate 60R which are retrieved from the storage unit 74 and input to the input units 71, 72, and 73 by the operations of the information retrieval operation units.

The control unit 70 controls the operation of the first robot 62L, the operation of the second robot 63, and the operation of the third robot 62R based on the offset position information of the left guide plate 60L, pieces of offset position information of the central guide bars 61L and 61R, and offset position information of the right guide plate 60R input to the input units 71, 72, and 73 by the operations of the offset operation units.

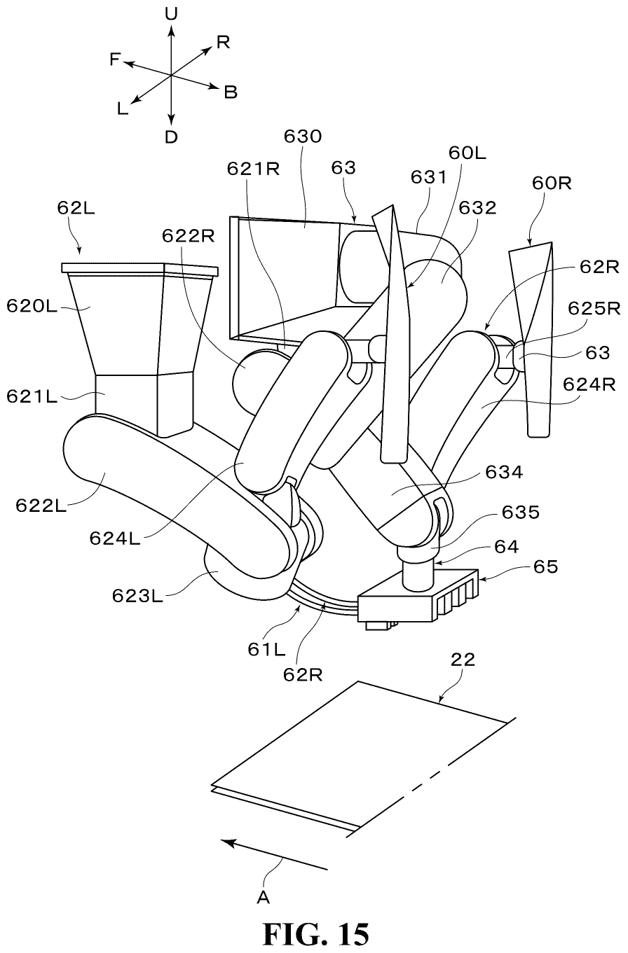

That is, the control unit 70 operates the first robot 62L, the second robot 63, and the third robot 62R (which may be referred to as “robots 62L, 63, and 62R” hereinafter) to cause the left guide plate 60L, the central guide bars 61L and 61R, and the right guide plate 60R (which may be referred to as “guides 60L, 61L, 61R, and 60R hereinafter”) to be located on a manufacturing line A, which is a target position, in target postures and to be offset from target positions illustrated in FIGS. 12 to 14 to offset positions illustrated in FIG. 15. The guides 60L, 61L, 61R, and 60R located at the offset positions illustrated in FIG. 15 are in a retracted state and greatly separated from the manufacturing line A which is the target position.

The position and posture adjustment device 7 controls the operations of the robots 62L, 63, and 62R as follows. That is, control is performed to operate the robots 62L, 63, and 62R via the control unit 70 when information on target positions and information on target postures are input to the input units 71, 72, and 73 in order to adjust positions and postures of the guides 60L, 61L, 61R, and 60R. In addition, control is performed to stop the operations of the robots 62L, 63, and 62R via the control unit 70 in order to maintain the adjusted positions and postures of the guides 60L, 61L, 61R, and 60R until information on the target positions and information on target postures are newly input to the input units 71, 72, and 73.

### Description of Functions of Embodiment

Hereinafter, the flap spreading device 6, the square bottom forming device 5, and the bag making machine 1 according to the embodiment are configured as described above, and functions thereof will be described hereinafter.

The paper feeding device 2 of the bag making machine 1 supplies the base paper 20. n the other hand, the handle device 3 of the bag making machine 1 forms the rope handles 34 each including the rope handle portion 32 and the attachment sheet 33, and attaches the rope handles 34 to the base paper 20 (see FIG. 4).

The flat tubular body forming device 4 of the bag making machine 1 forms the base paper 20 to which the rope handles 34 are attached into the continuous flat tubular body 21 (see FIG. 5), and forms the flat tubular body 22, provided with two sets of the rope handles 34 at the mouth portion 13, from the continuous flat tubular body 21 (see FIG. 6).

The square bottom forming device 5 of the bag making machine 1 opens the bottom portion 23 of the flat tubular body 22 (see FIG. 7), planarly spreads the opened bottom portion 23 of the flat tubular body 22 by the flap spreading device 6 (See FIGS. 8 and 9), and attaches the planarly spread bottom portion 23 of the flat tubular body 22 (see FIGS. 10 and 11). Thus, the square bottom bag 10 is formed (See FIGS. 3 and 11).

In a case where the square bottom bag 10 is to be formed from the new base paper 20, the bag making machine 1 operates the position and posture adjustment device 7 of the flap spreading device 6 to position the guides 60L, 61L, 61R, and 60R at optimal target positions in target postures on the new base paper 20. That is, the base paper 20 has different materials, thicknesses, and characteristics such as lots and recycle rates of waste paper. Therefore, it is necessary to adjust the positions and the postures of the guides 60L, 61L, 61R, and 60R by operating the position and posture adjustment device 7 for each base paper 20.

Here, the operation 41 the position and posture adjustment device 7 includes a case where the worker performs the operation and a case where the operation is performed by retrieving information stored in the storage unit 74.

Note that the formed square bottom bag 10 is randomly taken out to confirm the quality in the middle of the manufacturing process of the bag making machine 1. If the square bottom bag 10 is formed as designed, the manufacturing process proceeds without any change. However, when the square bottom bag 10 is not formed as designed, it is necessary to operate the position and posture adjustment device 7 to adjust the positions and the postures of the guides 60L, 61L, 61R, and 60R again to position the guides 60L, 61L, 61R, and 60R at optimal target positions in target postures.

In addition, there is a case where the positions and the postures of the guides 60L, 61L, 61R, and 60R are automatically adjusted in the middle of the manufacturing process of the bag making machine 1 based on the information stored in the storage unit 74 for each predetermined number of the square bottom bags 10, for example, per 100 units or per 1000 units, thereby causing the guides 60L, 61L, 61R, and 60R to be located at optimal target positions in target postures again.

Further, in addition to the above-described case, the positions and the postures of the guides 60L, 61L, 61R, and 60R are adjusted by operating the position and posture adjustment device 7 depending on an environment, a season, and the like in which the bag making machine 1 is operated, and also after the guide 60L, 61L, 61R, or 60R is replaced with another guide 60L, 61L, 61R, or 60R.

Here, when the position and posture adjustment device 7 is operated, the robots 62L, 63, and 62R operate so that the guides 60L, 61L, 61R, and 60R are adjusted to be located at optimal target positions in optimal target postures. In addition, until the position and posture adjustment device 7 is operated next, the robots 62L, 63, and 62R are in a stopped state, and a state in which the guides 60L, 61L, 61R, and 60R are located at the optimal target positions in the optimal target postures is maintained.

### Description of Effects of Embodiment

Hereinafter, the flap spreading device 6, the square bottom forming device 5, and the bag making machine 1 according to the embodiment have the above-described configurations and functions, and effects thereof will be described below.

The flap spreading device 6 according to the embodiment includes the pair of guide plates 60L and 60R on the left and right sides, the pair of left and right guide plate robots 62L and 62R having the pair of guide plates 60L and 60R on the left and right r sides as the end effectors, the pair of left and right guide bars 61L and 61R arranged between the pair of guide plates 60L and 60R on the left and right sides, the guide bar robot 63 having the pair of left and right guide bars 61L and 61R as the end effectors, and the position and posture adjustment device 7.

The position and posture adjustment device 7 adjusts positions and postures of the pair of guide plates 60L and 60R on the left and right sides in the three-dimensional space to target positions and target postures through the operations of the pair of left and right guide plate robots 62L and 62R, and adjusts positions and postures of the pair of left and right guide bars 61L and 61R in the three-dimensional space to target positions and target postures through the operation of the guide bar robot 63.

As a result, in the flap spreading device 6 according to the embodiment, the robots 62L, 63, and 62R can perform work of adjusting the guides 60L, 61L, 61R, and 60R, to be performed by the worker, so that the safety of the worker can be ensured.

Moreover, the flap spreading device 6 according to the embodiment can adjust the guides 60L, 61L, 61R, and 60R to optimal target positions and target postures in a short time. Thus, the flap spreading device 6 according to the embodiment can suppress a manufacturing loss of the square bottom bag 10 due to a long adjustment time, and can improve the manufacturing efficiency of the bag making machine 1. That is, the flap spreading device 6 according to the embodiment can suppress the manufacturing loss of the square bottom bag 10 and downtime of the bag making machine 1.

In the flap spreading device 6 according to the embodiment, the position and posture adjustment device 7 includes the first input unit 71, the second input unit 72, and the third input unit 73 each including the movement operation unit and receiving information on target positions and information on target postures of the guides 60L, 61L, 61R, and 60R, and the control unit 70 that controls the operations of the robots 62L, 63, and 62R based on the information on the target positions and the information on the target postures input to the first input unit 71, the second input unit 72, and the third input unit 73 by operating the movement operation units.

As a result, the flap spreading device 6 according to the embodiment can individually position the guides 60L, 61L, 61R, and 60R at the target positions in the target postures.

In the flap spreading device 6 according to the embodiment, the position and posture adjustment device 7 performs control to operate the robots 62L, 63, and 62R via the control unit 70 when the information on the target positions and the information on the target postures are input to the input units 71, 72, and 73 in order to adjust the positions and the postures of the guides 60L, 61L, 61R, and 60R, and performs control to stop the operations of the robots 62L, 63, and 62R via the control unit 70 until information on target positions and information on target postures are newly input to the input units 71, 72, and 73 in order to maintain the adjusted positions and postures of the guides 60L, 61L, 61R, and 60R.

As a result, in the flap spreading device 6 according to the embodiment, when the position and posture adjustment device 7 is operated, the robots 62L, 63, and 62R operate so that the guides 60L, 61L, 61R, and 60R are adjusted to be located at optimal target positions in optimal target postures. Thus, in the flap spreading device 6 according to the embodiment, the robots 62L, 63, and 62R operate instead of the worker without stopping the operation of the bag making machine 1, so that the positions and the postures of the guides 60L, 61L, 61R, and 60R can be adjusted, and the safety of the worker can be ensured.

Moreover, since the flap spreading device 6 according to the embodiment can adjust the positions and the postures of the guides 60L, 61L, 61R, and 60R through the operations of the robots 62L, 63, and 62R instead of the worker while operating the bag making machine 1, it is possible to grasp a subtle state or change of the square bottom 15 of the square bottom bag 10. Thus, the flap spreading device 6 according to the embodiment can shorten the adjustment operation time of the guides 60L, 61L, 61R, and 60R, and can improve the manufacturing efficiency of the square bottom bag 10.

In addition, the flap spreading device 6 according to the embodiment stops the operations of the robots 62L, 63, and 62R and maintains the adjusted positions and postures of the guides 60L, 61L, 61R, and 60R until the position and posture adjustment device 7 is operated next. Thus, the flap spreading device 6 according to the embodiment can continue the operation of the bag making machine 1 from the work of adjusting the positions and the postures of the guides 60L, 61L, 61R, and 60R, and can improve the manufacturing efficiency of the square bottom bag 10.

In the flap spreading device 6 according to the embodiment, the position and posture adjustment device 7 includes the storage unit 74 in which information on target positions and information on target postures are stored, the input units 71, 72, and 73 include the information retrieval operation units that retrieve the information on the target positions and the information on the target postures stored in the storage unit 74, and the control unit 70 controls the operations of the robots 62L, 63, and 62R based on the information on the target positions and the information on the target postures retrieved from the storage unit by the operation of the information retrieval operation units.

As a result, the flap spreading device 6 according to the embodiment can adjust the guides 60L, 61L, 61R, and 60R in a shorter time than that in the adjustment by operating the movement operation units. Thus, the flap spreading device 6 according to the embodiment can suppress a manufacturing loss of the square bottom bag 10 due to a long adjustment time, and can improve the manufacturing efficiency of the bag making machine 1.

Here, since the information on the target positions and the information on the target postures are obtained by digitizing adjustment performed by the skilled worker into a database, it is possible to reproduce highly accurate and skilled adjustment, acquired by the skilled worker through many years of experience, and it is possible to improve the manufacturing efficiency. Moreover, by associating information such as characteristics and properties of the base paper 20 and information such as an environment and a season in which the bag making machine 1 is operated with adjustment information of the skilled worker, adjustment with higher accuracy can be obtained, and the manufacturing efficiency can be further improved.

In the flap spreading device 6 according to the embodiment, the first input unit 71, the second input unit 72, and the third input unit 73 include the offset operation units that input offset position information for causing the guides 60L, 61L, 61R, and 60R, located at target positions in target postures, to be located at offset positions offset from the target positions, and the control unit 70 causes the guides 60L, 61L, 61R, and 60R to be located at the offset positions illustrated in FIG. 15 offset from the target positions illustrated in FIGS. 12 to 14 through the operations of the robots 62L, 63, and 62R by operating the offset operation units.

As a result, the flap spreading device 6 according to the embodiment can offset the guides 60L, 61L, 61R, and 60R significantly away from the manufacturing line A as illustrated in FIG. 15 when the base paper 20, the rope handle 34, and the square bottom bag 10 are clogged, or when a die of the square bottom bag 10 is replaced. Thus, the flap spreading device 6 according to the embodiment can easily perform unclogging work or die replacement work.

In the flap spreading device 6 according to the embodiment, the pair of guide plates 60L and 60 on the left and right sides is mounted to the pair of left and right guide plate robots 62L and 62R via the joints 64 and the buffer materials 644. As a result, when the pair of guide plates 60L and 60 on the left and right sides presses the flat tubular body 22 against the outer peripheral surface of the bottom folding drum 52 in the flap spreading device 6 according to the embodiment, the flat tubular body 22 is buffered by the buffer materials 644 to come into close contact with the outer peripheral surface of the bottom folding drum 52, so that the highly accurate square bottom bag 10 can be manufactured.

In the flap spreading device 6 according to the embodiment, the guide bar mounting member 65 is mounted to the guide bar robot 63, and the pair of left and right guide bars 61L and 61R is mounted to the guide bar mounting member 65 so as to be movable in the conveyance direction (front-rear direction) of the bottom folding drum 52 and a direction (left-right direction) intersecting the conveyance direction of the bottom folding drum 52. As a result, the flap spreading device 6 according to the embodiment can manually adjust positions of the pair of left and right guide bars 61L and 61R in the left-right direction and the front-rear direction separately for the single guide bar robot 63.

In the flap spreading device 6 according to the embodiment, since the pair of left and right guide bars 61L and 61R are mounted to the single guide bar robot 63 via the guide bar mounting member 65, only one expensive robot is required, so that manufacturing cost of the device can be reduced.

In the flap spreading device 6 according to the embodiment, the guide bar mounting member 65 is mounted to the guide bar robot 63 via the buffer material 644. As a result, when the pair of left and right guide bars 61L and 61R presses the flat tubular body 22 against the outer peripheral surface of the bottom folding drum 52 in the flap spreading device 6 according to the embodiment, the flat tubular body 22 is buffered by the buffer material 644 to come into close contact with the outer peripheral surface of the bottom folding drum 52, so that the highly accurate square bottom bag 10 can be manufactured.

Since the square bottom forming device 5 according to the embodiment includes the flap spreading device 6 according to the embodiment, it is possible to achieve effects similar to the effects described above of the flap spreading device 6 according to the embodiment.

Since the bag making machine according to the embodiment includes the square bottom forming device 5 according to the embodiment, it is possible to achieve the same effects as the effects of the square bottom forming device 5 according to the embodiment and the flap spreading device 6 according to the embodiment.

### Comparative Description Between Embodiment and Comparative Example

Hereinafter, the adjustment of positions and postures of the guides 60L, 61L, 61R, and 60R in the three-dimensional space by the flap spreading device 6 according to the embodiment and adjustment of positions and postures of the guides 60L, 61L, 61R, and 60R in the three-dimensional space by a flap spreading device of a comparative example will be described in comparison. Note that, among components of the flap spreading device of the comparative example, the same components as those of the flap spreading device 6 according to the embodiment will be denoted by the same reference signs.

In the flap spreading device 6 according to the embodiment, when the worker operates the position and posture adjustment device 7, the robots 62L, 63, and 62R adjust positions and postures of the guides 60L, 61L, 61R, and 60R in the three-dimensional space instead of the worker. On the other hand, in the flap spreading device of the comparative example, a worker manually adjusts positions and postures of the guides 60L, 61L, 61R, and 60R in the three-dimensional space.

Therefore, in the flap spreading device of the comparative example, it is necessary to stop the operation of the entire bag making machine 1 in order to ensure the safety of the worker when the guides 60L, 61L, 61R, and 60R are to be adjusted. Thus, in the flap spreading device of the comparative example, when the adjustment of the guides 60L, 61L, 61R, and 60R increases, a loss of the square bottom bag 10 and downtime of the bag making machine 1 increase.

Moreover, the guides 60L, 61L, 61R, and 60R need to be adjusted in positions in the X-axis direction, positions in the Y-axis direction, positions in the Z-axis direction, and postures around the X-axis, postures around the Y-axis, and postures around the Z-axis in the three-dimensional space, and thus the adjustment work is complicated. When the worker performs the complicated adjustment work, it takes time for the work, and variation in adjustment accuracy occurs depending on the worker, and variation also occurs in quality of the manufactured square bottom bag 10.

Then, in the flap spreading device 6 according to the embodiment, the worker operates the position and posture adjustment device 7 to cause the robots 62L, 63, 62R to adjust the positions and the postures of the guides 60L, 61L, 61R, 60R in the three-dimensional space. Therefore, the flap spreading device 6 according to the embodiment can perform the adjustment work by the robots 62L, 63, and 62R without stopping the operation of the entire bag making machine 1, and can suppress the loss of the square bottom bag 10 and the downtime of the bag making machine 1. Moreover, in the flap spreading device 6 according to the embodiment, the robots 62L, 63, and 62R perform the adjustment work based on the control of the position and posture adjustment device 7 when the worker operates only the position and posture adjustment device 7, and thus, it is possible to shorten time for the work and to suppress the variation in the adjustment accuracy and the variation in the quality of the square bottom bag 10 caused by the worker, as compared with the flap spreading device of the comparative example.

### Description of Examples Other Than Embodiment

The bag making machine 1, the square bottom forming device 5, and the flap spreading device 6 according to the invention are not limited to the above embodiment.

In the above embodiment, the example in which the pair of guide plates 60L and 60R on the left and right sides and the pair of left and right guide plate robots 62L and 62R, and the pair of left and right guide bars 61L and 61R and the guide bar robot 63, are provided has been described. However, the invention may include the pair of guide plates 60L and 60R on the left and right sides and the pair of left and right guide plate robots 62L and 62R without including the pair of left and right guide bars 61L and 61R and the guide bar robot 63. In addition, the invention may include the pair of guide plates 60L and 60R on the left and right sides, the pair of left and right guide plate robots 62L and 62R, and the pair of left and right guide bars 61L and 61R without including the guide bar robot 63. That is, it is sufficient for the invention to be capable of adjusting positions and postures of the pair of guide plates 60L and 60R on the left and right sides by at least the pair of left and right guide plate robots 62L and 62R. A bag making machine, a square bottom forming device, and a flap spreading device of examples other than the embodiment can achieve substantially the same effects as the effects of the bag making machine 1, the square bottom forming device 5, and the flap spreading device 6 of the above embodiment.

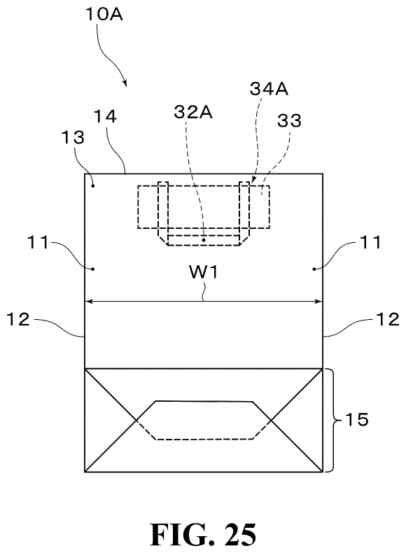

In the above embodiment, the bag making machine 1 that manufactures the square bottom bag 10 with the rope handles 34 illustrated in FIG. 3 has been described. However, a bag making machine according to the invention may be a bag making machine other than the bag making machine 1 that manufactures the square bottom bag 10 with the rope handles 34 illustrated in FIG. 3. For example, the bag making machine may be a bag making machine that manufactures a square bottom bag 10A with an external flat handle 34A (the square bottom bag 10A including the external flat handle 34A) illustrated in FIG. 25, a bag making machine that manufactures a square bottom bag with an internally folded flat handle (the square bottom bag including the internally folded flat handle), which is not illustrated, or a bag making machine that manufactures a square bottom bag having no handle (SOS bag) which is not illustrated.

Here, the bag making machine that manufactures the square bottom bag 10A with the external flat handle 34A and the bag making machine that manufactures the square bottom bag with the internally folded flat handle need to include a handle forming device that forms a flat handle 32A instead of the handle forming device 30 that forms the rope handle 34. In addition, the bag making machine that manufactures the square bottom bag having no handle does not require a handle forming device and a handle attaching device.

In the above embodiment, the example in which the pair of left and right guide bars 61L and 61R is mounted to the single guide bar robot 63 via the guide bar mounting member 65 has been described. However, in the invention, the pair of left and right guide bars 61L and 61R may be mounted to a pair of left and right guide bar robots via guide bar mounting members or the joints 64. In this case, the pair of left and right guide bars 61L and 61R can be individually and more finely adjusted. Thus, it is possible to cope with a case where finer adjustment of the pair of left and right guide bars 61L and 61R is required.

In the above embodiment, the storage unit 74 is provided. However, the invention does not necessarily include the storage unit 74.

1. A flap spreading device in a square bottom forming device of a bag making machine, the flap spreading device that folds back a front flap of a bottom portion of a flat tubular body, conveyed by a bottom folding drum, upside down with respect to a back flap and planarly spreads the front flap and the back flap along an outer peripheral surface of the bottom folding drum in the square bottom forming device of the bag making machine, the flap spreading device comprising:
a pair of guide plates that guides both side portions of the flat tubular body along a conveyance direction of the bottom folding drum to planarly spread the front flap and the back flap;
a pair of robots having the pair of guide plates as end effectors; and
a position and posture adjustment device that adjusts positions and postures of the pair of guide plates in a three-dimensional space to target positions and target postures through operations of the pair of robots.

2. The flap spreading device in the square bottom forming device of the bag making machine according to claim 1, wherein
the position and posture adjustment device includes:
an input unit including a movement operation unit that receives information on the target positions and information on the target postures of the pair of guide plates; and
a control unit that controls the operations of the pair of robots based on the information on the target positions and the information on the target postures input to the input unit by operating the movement operation unit.

3. The flap spreading device in the square bottom forming device of the bag making machine according to claim 2, wherein
the position and posture adjustment device performs
control to operate the pair of robots via the control unit when the information on the target positions and the information on the target postures are input to the input unit in order to adjust the positions and the postures of the pair of guide plates, and
control to stop the operations of the pair of robots via the control unit until information on the target positions and information on the target postures are newly input to the input unit in order to maintain the adjusted positions and postures of the pair of guide plates.

4. The flap spreading device in the square bottom forming device of the bag making machine according to claim 2, wherein
the input unit includes an offset operation unit that receives offset position information for causing the pair of guide plates, located at the target positions in the target postures, to be located at offset positions offset from the target positions, and
the control unit causes the pair of guide plates to be located at the offset positions offset from the target positions through the operations of the pair of robots by operating the offset operation unit.

5. The flap spreading device in the square bottom forming device of the bag making machine according to claim 2, wherein
the position and posture adjustment device includes a storage unit in which the information on the target positions and the information on the target postures are stored,
the input unit includes an information retrieval operation unit that retrieves the information on the target positions and the information on the target postures stored in the storage unit, and
the control unit controls the operations of the pair of robots based on the information on the target positions and the information on the target postures retrieved from the storage unit by operating the information retrieval operation unit.

6. The flap spreading device in the square bottom forming device of the bag making machine according to claim 5, wherein
the input unit includes an offset operation unit that receives offset position information for causing the pair of guide plates, located at the target positions in the target postures, to be located at offset positions offset from the target positions, and
the control unit causes the pair of guide plates to be located at the offset positions offset from the target positions through the operations of the pair of robots by operating the offset operation unit.

7. The flap spreading device in the square bottom forming device of the bag making machine according to claim 1, wherein
the pair of guide plates is attached to the pair of robots via a joint and a buffer material.

8. The flap spreading device in the square bottom forming device of the bag making machine according to claim 1, further comprising:
a pair of guide bars that is arranged between the pair of guide plates and guides a central portion of the flat tubular body along the conveyance direction of the bottom folding drum to planarly spread the front flap and the back flap; and
a guide bar robot having the pair of guide bars as end effectors,
wherein the position and posture adjustment device adjusts positions and postures of the pair of guide bars in the three-dimensional space to target positions and target postures through an operation of the guide bar robot.

9. The flap spreading device in the square bottom forming device of the bag making machine according to claim 8, wherein
the position and posture adjustment device includes:
an input unit including a movement operation unit that receives information on the target positions and information on the target postures of the pair of guide bars; and
a control unit that controls the operation of the guide bar robot based on the information on the target positions and the information on the target postures input to the input unit by operating the movement operation unit.

10. The flap spreading device in the square bottom forming device of the bag making machine according to claim 9, wherein
the position and posture adjustment device performs
control to operate the guide bar robot via the control unit when the information on the target positions and the information on the target postures are input to the input unit in order to adjust the positions and the postures of the pair of guide bars, and
control to stop the operation of the guide bar robot via the control unit until information on the target positions and information on the target postures are newly input to the input unit in order to maintain the adjusted positions and postures of the pair of guide bars.

11. The flap spreading device in the square bottom forming device of the bag making machine according to claim 8, wherein
a guide bar mounting member is mounted to the guide bar robot, and
the pair of guide bars is mounted to the guide bar mounting member to be movable in at least one of the conveyance direction of the bottom folding drum and a direction intersecting the conveyance direction of the bottom folding drum.

12. The flap spreading device in the square bottom forming device of the bag making machine according to claim 8, wherein
a guide bar mounting member is mounted to the guide bar robot via a joint and a buffer material, and
the pair of guide bars is mounted to the guide bar mounting member to be movable in at least one of the conveyance direction of the bottom folding drum and a direction intersecting the conveyance direction of the bottom folding drum.

13. A square bottom forming device in a bag making machine, the square bottom forming device that forms a bottom portion of a flat tubular body into a square bottom in the bag making machine, the square bottom forming device comprising:
a supply device that continuously supplies the flat tubular body at intervals;
a bottom fold line forming device that forms a bottom fold-back line and a bottom folding line to the bottom portion of the flat tubular body in a direction perpendicular to a flow direction of a manufacturing line;
a bottom folding drum that conveys the flat tubular body in the flow direction of the manufacturing line;
an opening device that opens a front flap and a back flap of the bottom portion of the flat tubular body;
the flap spreading device according to claim 1, the flap spreading device folding back the front flap inside out with respect to the back flap along the bottom fold-back line and planarly spreading the front flap and the back flap along an outer peripheral surface of the bottom folding drum;
a glue applicator that applies glue to the front flap and the back flap which are planarly spread;
a raising device that raises the front flap and the back flap to which the glue is applied along the bottom folding line;
a sticking device that folds the raised front flap and the raised back flap along the bottom folding line and sticks the front flap and the back flap to each other with the glue; and
a pressing device that presses the front flap and the back flap stuck with the glue to form the square bottom.

14. A bag making machine that manufactures a square bottom bag, the bag making machine comprising:
a paper feeding device that continuously feeds base paper wound in a roll shape in a flow direction of a manufacturing line;
a flat tubular body forming device that forms a flat tubular body having a flat tubular shape from the base paper fed from the paper feeding device; and
the square bottom forming device according to claim 13, the square bottom forming device forming a square bottom from a bottom portion of the flat tubular body formed by the flat tubular body forming device.

15. The bag making machine according to claim 14, further comprising a handle device that forms a handle and attaches the handle to a predetermined position of a mouth portion of the square bottom bag.
